(19) United States
(12) Patent Application Publication
(10) Pub. No.: US 2006/0034064 A1
(43) Pub. Date: Feb. 16, 2006

(54) Illuminated safety vest

(76) Inventors: James Kanzler, Volo, IL (US); Michael V. Coscino JR., Bartlett, IL (US)

Correspondence Address: WELSH & KATZ, LTD, 120 S RIVERSIDE PLAZA, 22ND FLOOR, CHICAGO, IL, 60606, US

(21) Appl. No.: 10/918,263

(22) Filed: Aug. 13, 2004

(51) Int. Cl. F21V 9/16

(52) U.S. Cl. 362/84; 362/108

(57) ABSTRACT

The illuminated safety vest comprising a front panel and a back panel integrally connected together with first and second spaced apart over-the-shoulder strips which form a head opening, one of the front panel or back panel having connecting structure for connecting the front or back panel to the back or front panel; reflector strips on the front panel; reflector strips on the back panel; the reflector strips including a strip which extends on each one of the over-the-shoulder strips; one of the front panel or back panel having on the inner surface thereof a pocket; a power supply inverter unit being received in the pocket and being connected to a continuous electro-luminescent wire which is arranged in a first configuration on the front panel adjacent the reflector strips and in a second configuration on the back panel adjacent the reflector strips.

### BACKGROUND OF THE INVENTION

1. Field of the Invention

The present invention relates to an illuminated vest which comprises front and back panels integrally connected by over-the-shoulder strips and having reflector strips on the front panel, reflector strips on the back panel, an electro-luminescent, EL, wire on the panels and connected to an inverter/power supply received in an inside pocket on one of the panels, the EL wire extending in a first configuration on the front panel and in a second configuration on the back panel and side straps for connecting the sides of the panels together.

2. Description of the Related Art

Heretofore, it has been proposed to mount strips of electro-luminescent material on articles of clothing, such as a vest. See U.S. Pat. No. 5,570,745.

Also it has been proposed to use electro-luminescent, EL, wire for illuminating items. For example, U.S. Pat. No. 6,758,314 teaches a reel of electro-luminescent (EL) wire. The EL wire can be pulled off the reel and fixed to stakes or posts to form a lighted fence.

Furthermore, it has been proposed to attach EL wire to an article of clothing including shirts and vests. See U.S. Published patent applications No.'s 2001/0004808 and 2003/0231485.

### BRIEF SUMMARY OF THE INVENTION

According to one of the teachings of the present invention there is provided an illuminated safety vest comprising a front panel and a back panel integrally connected together with first and second spaced apart over-the-shoulder strips which form a head opening, one of the front panel or back panel having connecting structure for connecting the front or back panel to the back or front panel; reflector strips on the front panel; reflector strips on the back panel; the reflector strips including a strip which extends on each one of the over-the-shoulder strips; one of the front panel or back panel having on the inner surface thereof a pocket; a power supply inverter unit being received in the pocket and being connected to a continuous electro-luminescent, EL, wire which is arranged in a first configuration on the front panel adjacent the reflector strips and in a second configuration on the back panel adjacent the reflector strips.

### BRIEF DESCRIPTION OF THE SEVERAL VIEWS OF THE DRAWINGS

FIG. 1A is a front plan view of a front panel of one safety vest constructed according to the teachings of the present invention.

FIG. 1B is a back plan view of a back panel of the vest shown in FIG. 1A.

FIG. 1C is a phantom view of the front panel of the vest shown in FIG. 1A with the exception that a power supply inverter, coupling wire and an electro-luminescent, EL, wire forming a “V” in the front of the front panel of the vest at a V neck are shown in solid lines.

FIG. 1D is a is a phantom view of the back panel of the vest shown in FIG. 1B but shown in phantom with the exception that the electro-luminescent wire is shown extending in solid lines in a generally square “U” configuration on the back panel of the vest.

FIG. 2A is a front plan view of a front panel of another safety vest constructed according to the teachings of the present invention which has an electro-luminescent wire arranged in a “V” configuration on the front panel of the vest.

FIG. 2B is a back plan view of a back panel of the vest shown in FIG. 2A and shows an electro-luminescent wire which has a partially undulating or generally block “W” configuration thereon as opposed to the generally block “U” configuration shown in FIG. 1D.

FIG. 3A is a front plan view of a front panel of still another safety vest constructed according to the teachings of the present invention which is similar to the vest shown in 1A but shows a different reflector strip configuration on the front panel of vest.

FIG. 3B is a back plan view of a back panel of the vest shown in FIG. 3A but shows a different reflector strip configuration on the back panel of the vest.

FIG. 4A is a front plan view of a front panel of another safety vest constructed according to the teachings of the present invention wherein the front panel comprises separate side panels which can be fastened together with a zipper or buttons, much like the front of a sleeveless cardigan sweater.

FIG. 4B is a back plan view of a back panel of the vest shown in FIG. 4A.

FIG. 5A is a front plan view of a front panel of still another safety vest constructed according to the teachings of the present invention wherein the front panel is made out of a lightweight, porous, breathable material and an electro-luminescent, EL, wire is fixed to the front panel in a generally block “U” configuration.

FIG. 5B is a back plan view of a back panel of the safety vest shown in FIG. 5A wherein the back panel is made out of a lightweight, porous, breathable material and an electro-luminescent wire is fixed to the back panel in a generally block “U” configuration.

### DETAILED DESCRIPTION OF THE INVENTION

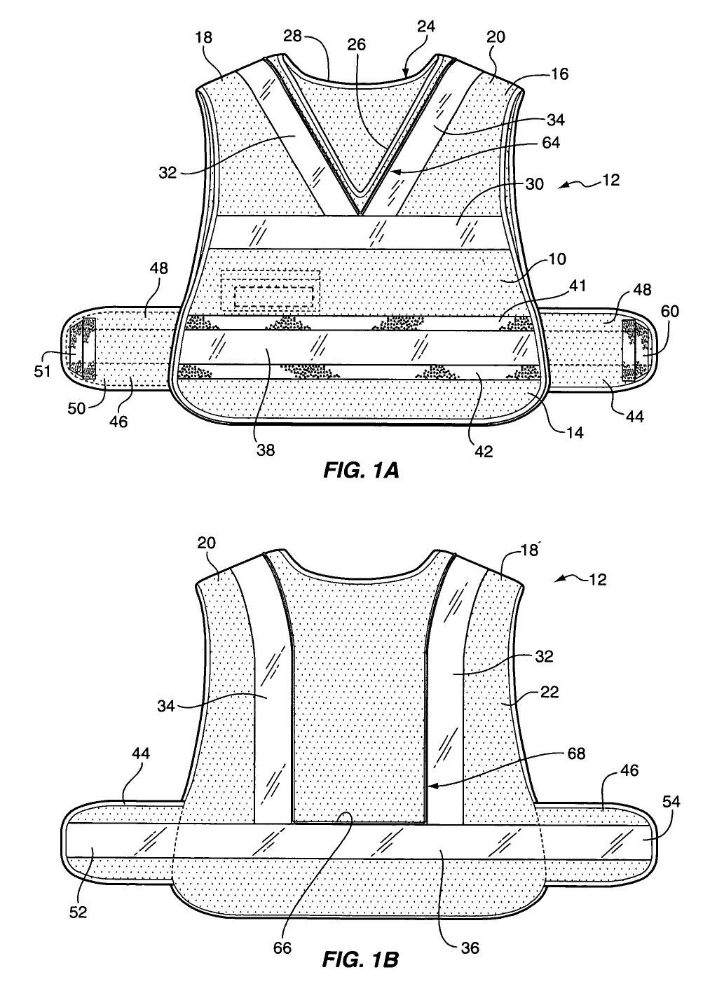

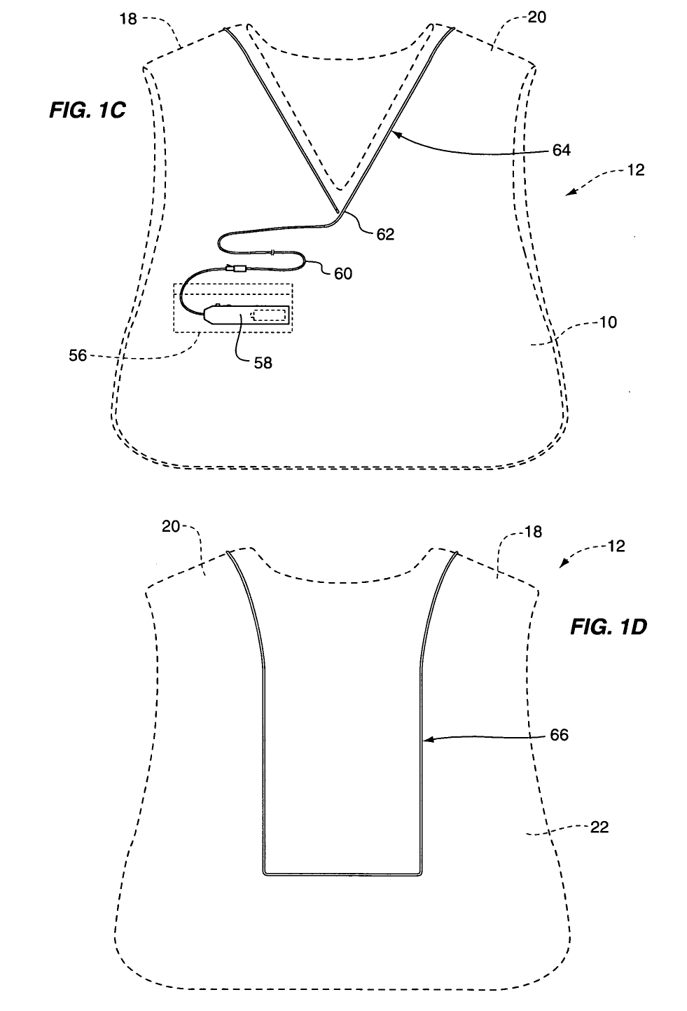

Referring now to the drawings in greater detail, there is illustrated in FIG. 1A a first embodiment of a front panel 10, of a safety vest 12, constructed according to the teachings of the present invention. The front panel 10 has a generally rectangular shape with rounded lower corners, and slightly curved side edges extending from a wider bottom portion 14 up to a slightly narrower shoulder portion 16. It will be understood that the upper part of the front panel includes spaced apart over-the-shoulder strips 18 and 20. The strips 18 and 20 which extend over-the-shoulder to a back panel 22 of the vest 12 and, together with the front and back panels 10 and 22, form a head opening 24. The front panel 10 has a V edge 26 at the top to form a V-neck head opening 24. The a back panel 22 has a slightly curved upper edge 28 for completing the head opening 24 with the over-the-shoulder strips 18 and 20 completing the perimeter or border of the head opening 24.

A first, generally horizontally extending, transverse, reflector strip 30 extends across the front panel 10. A pair of V forming, reflector strips 32 and 34 extend upwardly at an angle from the first reflector strip 30 adjacent to but slightly spaced from the V edge 26. Each strip 32, 34 then extends in a slight arc on and over the shoulder strips 18 and 20 and slightly inwardly of and on the back panel 22 and then down to a fourth, lower, generally horizontally extending transverse reflector strip 36 on the back panel 22.

The front panel 10 also has a fifth, lower, generally horizontally extending reflector strip 38 parallel spaced from the first reflector strip 30. The lower reflector strip 38 on the front panel is aligned with or overlays the lower reflector strip 36 on the back panel 22.

The front panel 10 also has first and second hook or loop strips 41 and 42 adjacent the fifth, lower reflector strip 38.

Referring to FIG. 1B, the back panel 22 has first and second side straps 44 and 46 extending outwardly from the sides of the back panel 22 with the fourth, lower reflector strip 36 extending on and across the side straps 44 and 46. As shown in FIG. 1A, an inner surface 48 on an outer end 49 or 50 of each strap 44, 46 has a section or pad 50 or 51 of loop or hook material thereon whereby the straps 44 and 46 can be affixed, releaseably, to the hook or loop material strips 41, 42 on the front panel 10. The hook and loop material is of the type sold under the trademark VELCRO.

It will be understood that the straps 44 and 46 enable the vest 12 to be fixed about individuals with varying and/or different size waists and with ends 52 and 54 of the fourth, lower reflector strip 36 on the straps 44 and 46 mating or being aligned with the fifth, lower reflector strip 38 on the front panel 10.

As shown, the vest panels 10 and 22 are made of a lightweight, porous, breathable material and can be colored lime yellow or orange. The reflector strips 30-38 can be lime yellow reflective, orange reflective or silver reflective.

As shown in phantom in FIG.1 A the front panel has a pocket 56 on an inside surface thereof which receives an inverter/power supply 58. The inverter/power supply 58 is connected by wire conductors 60 to an electro-luminescent or EL wire 62 which extends in a first, V, configuration 64 adjacent the reflector strip 32 and 34 and between the V edge 26 of the V neck 24 and the reflector strips 32 and 34. Then the EL wire 62 extends on the over-the-shoulder strips 18 and 20 and downwardly along an inner edge of each reflector strip 32, 34 on the back panel 22 to the fourth, lower reflector strip 36 on the back panel 22. Then the EL wire 62 extends along an upper edge 66 of the fourth reflector strip 36 between the reflector strips 32 and 34. In this way the EL wire 62 forms the first configuration, namely a V configuration 64 on the front panel 10, as shown in FIG. 1C and then a second configuration, namely a generally block “U” configuration 68 on the back panel 22 as shown in FIG. 1D.

The electro-luminescent, EL, wire 62 can be of the type which emits a desired light such as a chartreuse or yellow green light or an orange light. Of course other color lighted EL wires can be used as desired. Also, it will be understood that the inverter/power supply 58 has a two or three-position switch, i.e., on/off or on/blink/off.

The construction of the vest 12, as described above provides an illuminated safety vest 12 which is lightweight and inexpensive while providing ample reflection by reason of the reflector strips 30-38 and adequate illumination by reason of the first and second configurations 64 and 68 of the EL wire 62 on the front panel 10 and back panel 22.

Referring to FIG'S. 2A and 2B there is illustrated therein another embodiment of a vest 70 constructed according to the teachings of the present invention. In this embodiment the material of the front and back vest panels 72 and 74 is heavier. There is provided only one, generally horizontally extending reflector strip 76 on the front panel 72 and one, generally horizontally extending reflector strip 78 on the back panel 74. Also, the reflector strips 76 and 78 have border strips 76a, 76b and 78a and 78b on either side thereof.

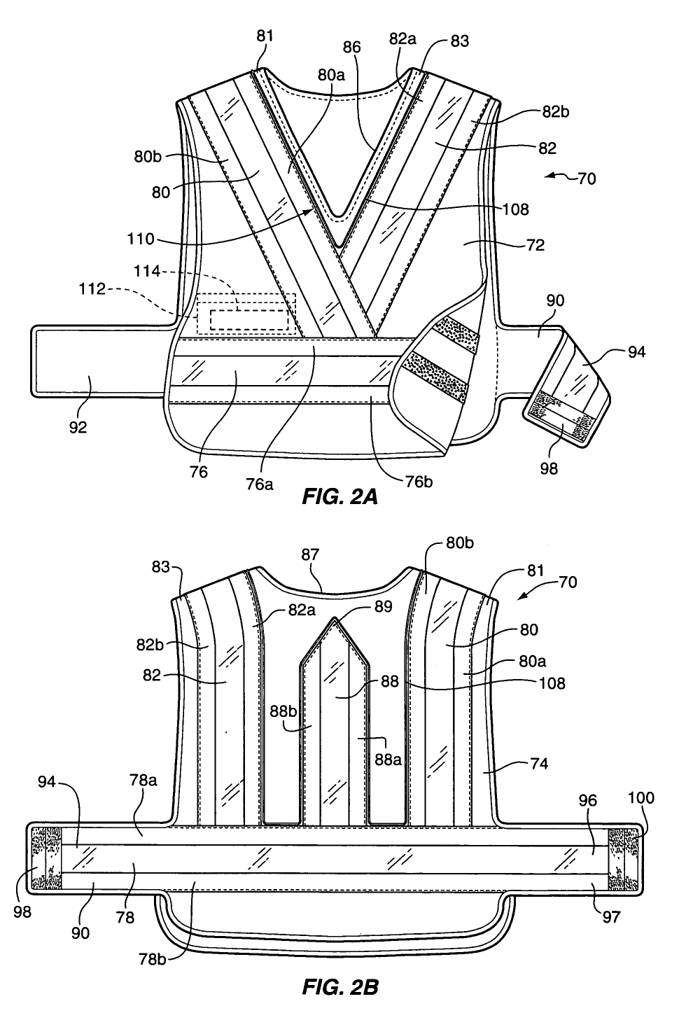

Further, as shown in FIG. 2A, a similar reflector strip 80, 80a and 80b, extends angularly upwardly from the upper border strip 76a of the generally horizontally extending reflector to and on an over-the-shoulder strip 81 of the vest 70 and then downwardly on the back panel 74 to the generally horizontally extending, reflector strip 78, 78a and 78b on the back panel 74. Then a further similar reflector strip 82, 82a and 82b extends upwardly at an angle to and on a second over-the shoulder strip 83 of the vest 70 and then downwardly to the generally horizontally extending reflector strip 78, 78a and 78b. The two reflector strips 80, 80a, 80b and 82, 82a, 82b form a V and the vest 70 has a V neck opening 86 including a front V 86a and a short U 86b between the over the shoulder strips 81 and 83 and a curved upper inner edge 87 of the back panel 74.

On the back panel 74, a short generally upright reflector strip 88, 88a, 88b extends upwardly from the reflector strip 78, 78a, 78b. to a point 89 spaced a short distance from the upper edge 87. The point 89 is at the apex of a V cut of the reflector strip 88, 88a, 88b.

Two straps 90 and 92 extend from opposite sides of the back panel 74 and the reflector strip 78, 78a, 78b has end portions 94 and 96 that extend onto the straps 90 and 92, each to a pad 98 or 100 of hook and loop material on the outer surface of the reflector strip end portions 94 and 96.

Then, on the inner surface of the front panel 72, there is provided two transversely extending strips 104, 106 of loop and hook material for fixing the straps 90 and 92 to and behind the front panel 72.

Like in the vest 12 shown in FIG∝S. 1A-1D, an electro-luminescent (EL) wire 108 is arranged in a first, generally V shaped configuration 110 on the front panel 72 and in a second, generally block W shaped configuration 112 on the back panel 74. The EL wire 108 on the front panel 72 extends upwardly adjacent reflector strip border strips 80a and 82a to form the V shape 110. Then, on the back panel 74, the EL wire 108 extends downwardly along the inner border strip 80a to the transversely extending reflector strip 78, border strip 78a and then along the border strip 78a to the border strip 88b, up and around the point 89, down along border strip 88a to transversely extending reflector strip 78a, across to border strip 82a and up along border strip 82a to the top of the vest 70 in a generally block W configuration.

As in the first embodiment, the vest 70 has a pocket 112 on the inside of the front panel 72 for an inverter/power supply 114. The inverter/power supply 114 is connected by wire conductors (not shown) like wire conductors 60 in the FIG. 1A-1D embodiment, to the EL wire 108.

The vest 70, in addition to having border strips, has a different strap configuration. In this respect, first and second straps 90 and 92 are constructed to fasten beneath the front panel 72 instead of above and on the front panel 72.

The vest 70 is preferably color lime yellow. The EL wire preferably emits a yellow-green light and the reflector strips 76, 78, 80, 82 and 88 are preferably reflective silver strips. The border strips 76a, 76b, 78a, 78b, 80a, 80b, 82a, 82b, 88a and 88b are preferably retro-flective orange strips. The hook and loop pads 98, 100 and the hook and loop strips 104, 106 are preferably colored orange.

Referring now to FIG'S. 3A and 3B, there is illustrated therein another embodiment of a vest 120 constructed according to the teachings of the present invention which is slightly different from the vest 12, shown in FIG.'S 1A-1D. In this embodiment the vest 120 includes a front panel 122 and a back panel 124 which has an upper, generally horizontally and transversely extending reflector strip 125 as well as a lower generally horizontally and transversely extending reflector strip 126. The back panel 124 has similar upper and lower reflector strips 127 and 128. Two reflector strips 129 and 130 extend on the front panel upwardly in diverse angles from the middle of the reflector strip 125 to over the shoulder strips 131 and 132 of the vest 120 and then downwardly on the back panel 124 to the upper reflector strip 127.

The vest has a V-neck opening 133 with an apex 134 of the V-neck opening 133 being located above the upper generally horizontally extending reflector strip 125.

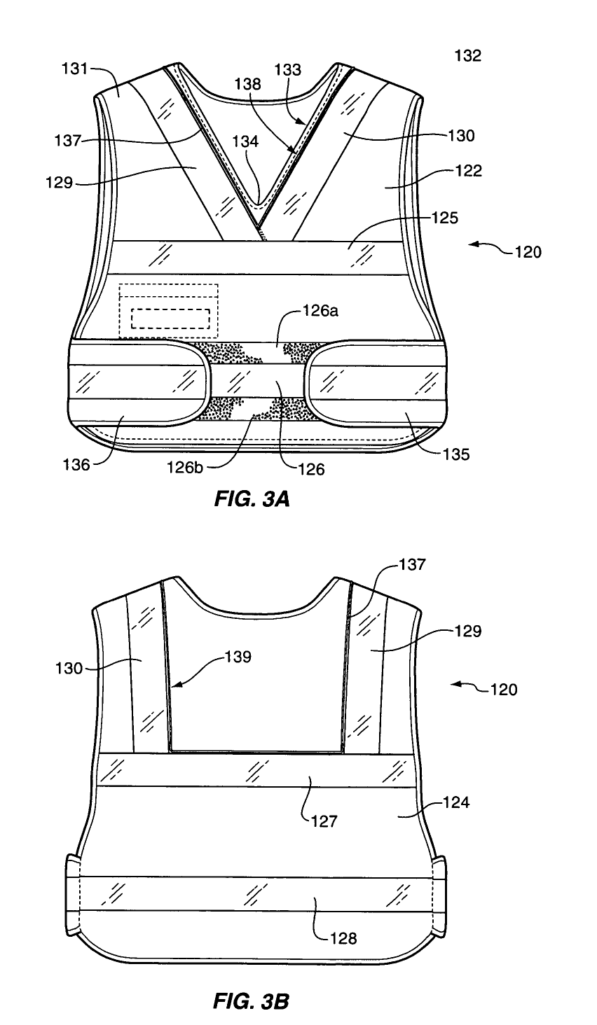

Also, in FIG. 3A side straps 135 and 136 are shown which have hook and loop material on an inner surface thereof for fixing to hook and loop strips 126a and 126b above and below reflector strip 126 on the front panel 122.

An EL wire 137 extends in a V configuration 138 on the front panel 122 and in a generally block U shaped configuration 139 on the back panel 124.

The vest 120 preferably has one of two color combinations, namely, vest 120—yellow green, EL wire 137 emitting yellow green light and the reflector strips being reflective yellow green or reflective silver; the other color combination is: vest 120—orange, EL wire 137 emitting orange light and the reflector strips being reflective orange or reflective silver.

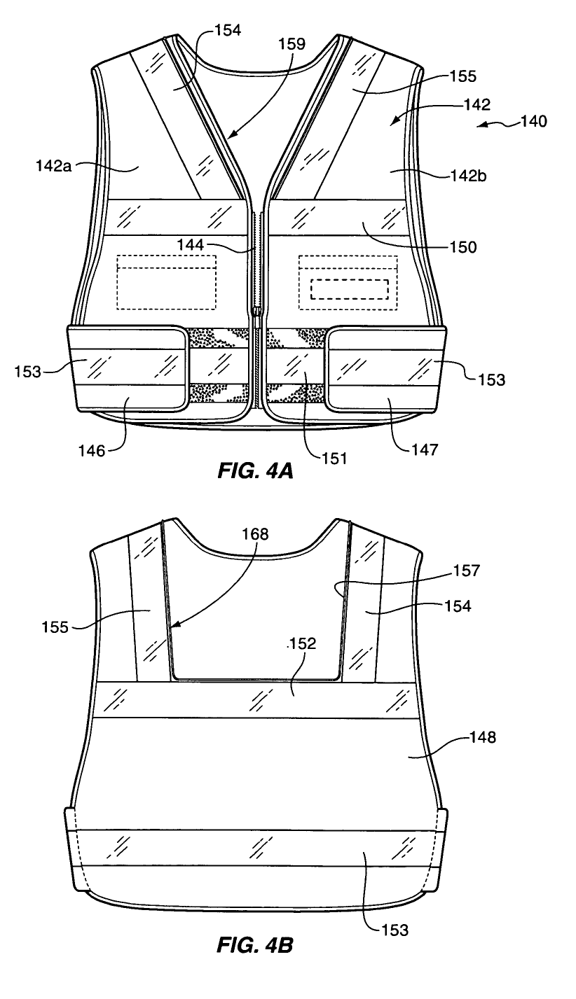

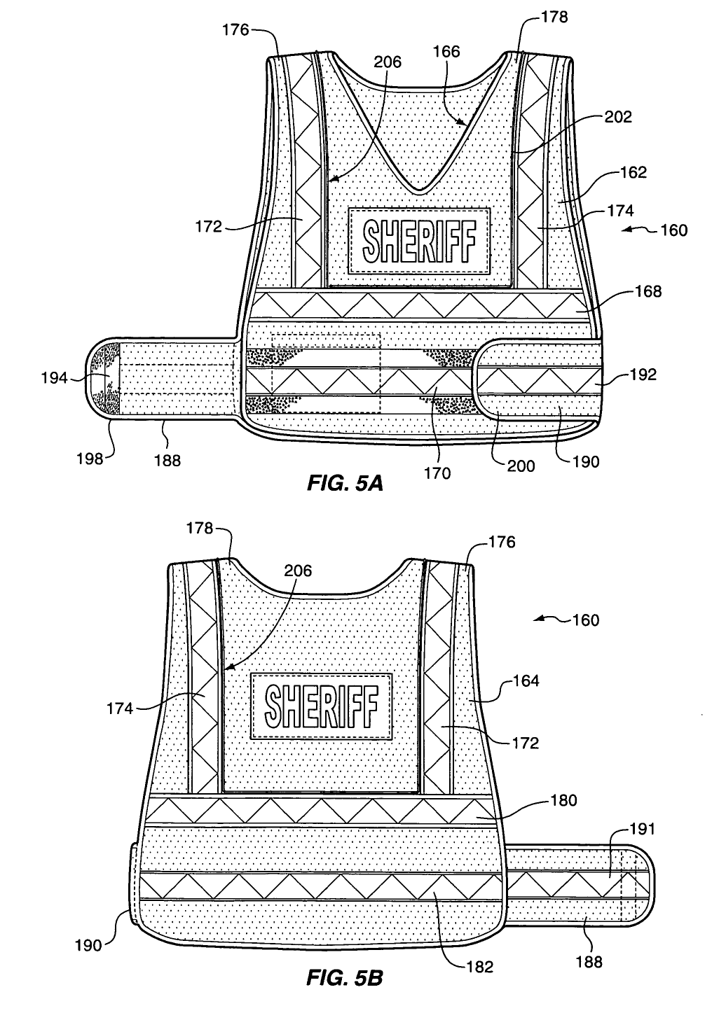

A further embodiment of an illuminated vest 140 is shown in FIG.'S 4A and 4B and is similar to the vest shown in FIG.'S 3A and 3B but shows a front panel 142 in FIG. 4A, which has first and second side panels 142a and 142b which are connected in the middle of the front panel 142 by a zipper 144 so that the vest 140 can be opened by unzipping a zipper 144 or by pulling away side straps 146 and 148 that extend from sides of a back panel 148 of the vest 140. This construction is similar to a sleeveless cardigan sweater.

In other respects, the vest 140 is generally the same as the vest 120 having upper and lower reflector strips 150 and 151 on the front panel sections 142a and 142b, upper and lower reflector strips 152 and 153 on the back panel 148, two oppositely diverging reflector strips 154 and 155 on the front panel sections 142a and 142b, an EL wire 156 arranged in a V configuration 157 on the front panel sections 142a and 142b and a generally block U configuration 158 on the back panel 148 adjacent reflector strips 154 and 155 as well as strip 152 on the back panel 148, and with the vest having a V-neck opening 159.

The vest 140 preferably has one of two color combinations, namely, vest 140—yellow green, EL wire 157 emitting yellow green light and the reflector strips being reflective yellow green or reflective silver; the other color combination is: vest 140—orange, EL wire 157 emitting orange light and the reflector strips being reflective orange or reflective silver.

FIG.'S 5A and 5B illustrate a still further embodiment of a vest 160 constructed according to another teaching of the present invention. This vest 160 is similar to the vests 12 and 120 shown in FIG.'S 1A, 1B, 3A and 3B. As shown the vest 160 is made of a lightweight, porous, breathable material and includes a front panel 162 and a back panel 164. The front panel 162 has a V-neck 166.

On the front panel 162 there are upper and lower, spaced apart, transversely and generally horizontally extending reflector strips of 168 and 170 and left and right, spaced, generally vertically extending reflector strips 172 and 174 which extend upwardly from the upper reflector strip 168 to and on, respectively, over the shoulder strip[s 176 and 178 of the vest 160 and downwardly on the back panel 164 to an upper, transversely and generally horizontally extending reflector strip 180. The back panel also has a spaced lower, transversely and generally horizontally extending reflector strip 182 as shown. The reflector strip 168 is generally aligned with the reflector strip 180 and the reflector strip 170 is generally aligned with the reflector strip 182 as shown.

Above and below the upper reflector strip 168 are located strips 184 and 186 of hook and loop material. Then, extending from an inside layer of the back panel 164, on each side thereof are side straps 188 and 190 having reflector strip extensions 191 and 192 which are aligned with reflector strip 182 and intended to be aligned with reflector strip 170 when the straps are fixed to the hook and loop strips 184 and 186 by loop and hook pads 194 on the inside at an end 198 or 200 of each strap 188 and 190.

Although not shown, it will be understood that an inside layer of the front panel 162 has a pocket receiving an inverter/power supply unit which is connected by wire conductors to an EL wire 202 that extends in a generally block U configuration 204 adjacent reflector strips 168, 172 and 170 on the front panel 162 and in a generally block U configuration 206 adjacent reflector strips 170, 180 and 168 on the back panel 164 as shown in FIG'S. 5A and 5B.

The upper strips 168 and 180 are lower on the respective front and back panels 162 and 164 to provide a deeper, generally block U on the panel.

The vest 160 preferably has one of two color combinations, namely, vest 160—yellow green, EL wire 202 emitting yellow green light and the reflector strips being reflective yellow green or reflective silver; the other color combination is: vest 160—orange, EL wire 202 emitting orange light and the reflector strips being reflective orange or reflective silver.

From the foregoing description it will be understood that the safety vests 12, 70, 120, 140 and 160 of the present invention have a number of advantages, some of which have been described above and others of which are inherent in the invention.

For example, the safety vests 12, 70, 120, 140 and 160 have a simple and effective arrangement and geometry of reflector strips, arrangement of side straps with aligned reflector strips thereon and a simple, effective and inexpensive arrangement of EL wire on the front and back panels.

Also, it will be understood that modifications can be made to the safety vests 12, 70, 120, 140 and 160 of the present without departing from the teachings of the invention. For example, the EL wire can emit blue light if desired. Also the reflector strips can be fluorescent orange reflector strips.

Accordingly, the scope of the invention is only to be limited as necessitated by the following claims.

We claim:

1. An illuminated safety vest comprising a front panel and a back panel integrally connected together with first and second spaced apart over-the-shoulder strips which form a head opening, one of said front panel or back panel having connecting structure for connecting said front or back panel to said back or front panel; reflector strips on said front panel; reflector strips on said back panel; said reflector strips including a strip which extends on each one of said over-the-shoulder strips; one of said front panel or back panel having on an inner surface thereof a pocket; a power supply inverter unit being received in said pocket and being connected to a continuous electro-luminescent wire which is arranged in a first configuration on said front panel adjacent said reflector strips and in a second configuration on said back panel adjacent said reflector strips.

2. The illuminated safety vest of claim 1 wherein said first configuration of said electro-luminescent wire is a “V” configuration and said second configuration of said electro-luminescent wire is a generally block “U” configuration.

3. The illuminated safety vest of claim 1 wherein said configuration of said electro-luminescent wire is a “V” configuration and said second configuration of said electro-luminescent wire is a generally “W” configuration.

4. The illuminated safety vest of claim 1 wherein said configuration of said electro-luminescent wire is a block “U” configuration and said second configuration of said electro-luminescent wire is a block “U” configuration.

5. The illuminated safety vest of claim 1, wherein said front panel comprises first and second side panels which can be fixed together in the middle of said front panel and which can be opened in the middle of said front panel; said front panel has a “V” neck and said electro-luminescent wire extends from a bottom of said “V” neck on an inner side of one side panel of said front panel, upwardly over-the-shoulder, and downwardly to a point in the middle of said back panel, and then extends laterally to the other side of the “V” neck, upwardly over-the-shoulder and then downwardly along the other side of the “V” on the inner side of the other side panel of said front panel to the bottom of the “V” on the other side panel.

6. The illuminated safety vest of claim 1, wherein said front panel has a “V” neck.

7. The illuminated safety vest of claim 6, wherein said reflector strips on said front panel include two reflector strips forming a “V” which extend to a laterally extending transverse strip and said first configuration of said electro-luminescent wire is a “V” configuration that extends adjacent the “V” forming reflector strips.

8. The illuminated safety vest of claim 1, wherein said reflector strips on said front and back panels include two spaced elongate strips which extend on and over the over-the-shoulder strips to a generally horizontally extending strip on the front panel and a generally horizontally extending strip on the back panel.

9. The illuminated safety vest of claim 8, wherein said front and back panels are made of a lightweight porous material.

10. The illuminated safety vest of claim 9, wherein said front panel has a second, lower, generally horizontally extending reflector strip and said back panel has a second lower generally horizontally extending reflector strip.

11. The illuminated safety vest of claim 10, wherein said connecting structure includes first and second straps extending from opposite sides of one of the front panel or the back panel in the area of said second lower reflector strip which extends on each strap and when the strap is fixed to the other panel the reflector strip on the strap are aligned with said lower reflector strip on said other panel.

12. The illuminated safety vest of claim 1 1, wherein said other panel has hook or loop material thereon adjacent said lower reflector strip and an inner surface of each strap has a loop or hook material thereon for mating with the hook or loop on said other panel.

13. The illuminated safety vest of claim 1, wherein said reflector strips include a lower generally horizontally extending reflector strip on said front panel and a lower generally horizontally extending reflector strip on said back panel and said connecting structure includes first and second straps extending from opposite sides of one of the front panel or the back panel in the area of said second lower reflector strip which extends on each strap and when each strap is fixed to said other panel, said reflector strip on each strap is generally aligned with said lower reflector strip on said other panel.

14. The illuminated safety vest of claim 13, wherein said other panel has hook or loop material thereon adjacent said lower reflector strip and an inner surface of each strap has a loop or hook material thereon for mating with said hook or loop on said other panel.

15. The illuminated safety vest of claim 13, wherein said other panel has hook or loop material thereon adjacent said lower reflector strip and an outer surface of each strap has a loop or hook material thereon for mating with said hook or loop on said other panel.

16. The illuminated safety vest of claim 13 wherein said straps are fixed to an outer surface of said front panel.

17. The illuminated safety vest of claim 13 wherein said straps are fixed to an inner surface of said front panel.

18. The illuminated safety vest of claim 1, wherein said electro-luminescent wire is of the type which emits a chartreuse, yellow-green light.

19. The illuminated safety vest of claim 1, wherein said electro-luminescent wire is of the type which emits a blue light.

20. The illuminated safety vest of claim 1, wherein said electro-luminescent wire is of the type which emits a florescent orange light.
